(19) United States
(12) Patent Application Publication
(10) Pub. No.: US 2006/0068240 A1
(43) Pub. Date: Mar. 30, 2006

(54) Fuel cell system

(75) Inventor: Tadashi Matoba, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/235,120

(22) Filed: Sep. 27, 2005

(30) Foreign Application Priority Data
Sep. 28, 2004 (JP) 2004-281423

(51) Int. Cl. H01M 8/00

(52) U.S. Cl. 429/12

(57) ABSTRACT

An on-vehicle fuel cell system of the present invention has: a fuel cell stack which is mounted on a vehicle and generates power by using fuel gas and oxidant gas, the fuel cell stack including a water passage which performs cooling and humidification in an inside thereof; a water circulator which circulates water through the water passage; a water tank which reserves the water; a discharge device which discharges extra water from the water tank to an outside of the vehicle; and a discharge control device which controls the discharge of the water by the discharge device. The discharge control device makes a control not to discharge liquid-water to the outside of the vehicle in a case where a road surface condition immediately under the vehicle is estimated to be a predetermined road surface condition.

### BACKGROUND OF THE INVENTION

1. Field of the Invention

The present invention relates to a fuel cell system mounted on a vehicle, and particularly, to an improvement for appropriately discharging extra water in a system to the outside.

2. Description of the Related Art

As a countermeasure against environmental problems in recent years, in particular, against such problems as air pollution caused by exhaust gas of automobiles and the like and global warming caused by carbon dioxide, a fuel cell system enabling clean exhaust and high energy efficiency has attracted attention. The fuel cell system is an energy conversion system that causes an electrochemical reaction by supplying air and hydrogen serving as fuel to a hydrogen electrode and an air electrode in a fuel cell stack, and converts chemical energy into electrical energy. In the fuel cell system, it is only water that is generated by the electrochemical reaction, and exhaust gas containing a toxic substance and carbon dioxide are hardly emitted.

Incidentally, in the fuel cell system as described above, the generated water generated by the electrochemical reaction in the fuel cell stack is usually utilized for cooling or humidifying the fuel cell stack. However, under a situation, such as during a time of a high-load operation, where a large amount of water is generated in the fuel cell stack, an amount of water in the system becomes excessive, and there occurs a necessity to discharge the extra water. Accordingly, in the invention described in Japanese Patent Laid-Open Publication No. 2002-313403, a configuration is adopted, in which, in discharging the water from a fuel flow passage, the generated water is reserved in a reservoir portion provided under a fuel gas passage, and a level of the water in the reservoir portion is detected, and when the water level thus detected exceeds a preset upper-limit water level, the generated water in the reservoir portion is discharged from a lower part thereof.

### SUMMARY OF THE INVENTION

However, in the conventional technologies, external circumstances and the like are not considered in discharging the extra water to the outside. Therefore, in the case of mounting the fuel cell system on a vehicle, there is a possibility to do harm to a person, an automobile and the like around the vehicle concerned owing to careless discharge. For example, in such a place where a space allowing a person, an article, an automobile and the like to enter therein exists immediately under the vehicle, as a multi-storied parking having a floor surface formed of a mesh steel plate and a pit of a vehicle dock, when the discharge of the generated water is performed while the vehicle is moving or being stopped, there is a possibility that the generated water falls down on the person, the article, the automobile and the like which are present in the space immediately under the vehicle.

The present invention has been proposed in order to solve such disadvantages inherent in the conventional fuel cell system. It is an object of the present invention to provide an on-vehicle fuel cell system that is free from carelessly doing harm to a person, an article, an automobile and the like immediately under a vehicle by appropriately controlling discharge of water in response to a road surface or a floor surface immediately thereunder.

The first aspect of the present invention provides an on-vehicle fuel cell system comprising: a fuel cell stack which is mounted on a vehicle and generates power by using fuel gas and oxidant gas, the fuel cell stack including a water passage which performs cooling and humidification in an inside thereof; a water circulator which circulates water through the water passage; a water tank which reserves the water; a discharge device which discharges extra water from the water tank to an outside of the vehicle; and a discharge control device which controls the discharge of the water by the discharge device, wherein the discharge control device makes a control not to discharge liquid-water to the outside of the vehicle in a case where a road surface condition immediately under the vehicle is estimated to be a predetermined road surface condition.

The second aspect of the present invention provides a fuel cell system controlling method comprising: preparing a fuel cell stack which is mounted on a vehicle and generates power by using fuel gas and oxidant gas, the fuel cell stack including a water passage which performs cooling and humidification in an inside thereof, a water circulator which circulates water through the water passage, a water tank which reserves the water, and a discharge device which discharges extra water from the water tank to an outside of a vehicle, estimating a road surface condition immediately under the vehicle; and controlling the discharge device not to discharge liquid-water to the outside of the vehicle in a case where the road surface condition is estimated to be a predetermined road surface condition.

The third aspect of the present invention provides an on-vehicle fuel cell system comprising: a fuel cell stack which is mounted on a vehicle and generates power by using fuel gas and oxidant gas, the fuel cell stack including a water passage which performs cooling and humidification in an inside thereof; a water circulator which circulates water through the water passage; a water tank which reserves the water; discharge means for discharging extra water from the water tank to an outside of the vehicle; and discharge control means for controlling the discharge of the water by the discharge means, wherein the discharge control means makes a control not to discharge liquid-water to the outside of the vehicle in a case where a road surface condition immediately under the vehicle is estimated to be a predetermined road surface condition.

### BRIEF DESCRIPTION OF THE DRAWINGS

The invention will now be described with reference to the accompanying drawings wherein;

FIG. 1 is a schematic view showing a configuration of a fuel cell system of a first embodiment;

FIG. 2 is a schematic view showing a state of estimating a road surface condition in the fuel cell system of the first embodiment;

FIG. 3 is a flowchart showing a control of discharge in the fuel cell system of the first embodiment;

FIG. 4 is a diagram showing an operation status in a case of having detected a continuous displacement in a displacement estimator;

FIG. 5 is a diagram showing an operation status in a case of having detected an intermittent displacement in the displacement estimator;

FIG. 6 is a schematic view showing a configuration of a fuel cell system of a second embodiment;

FIG. 7 is a schematic diagram showing a state of receiving a discharge prohibition signal from a transmitter in the fuel cell system of the second embodiment;

FIG. 8 is a flowchart showing a control of the discharge in the fuel cell system of the second embodiment;

FIG. 9 is a schematic view showing a configuration of a fuel cell system of a third embodiment; and

FIG. 10 is a flowchart showing a control of the discharge in the fuel cell system of the third embodiment.

### DETAILED DESCRIPTION OF THE PREFERRED EMBODIMENT

Hereinafter, description will be made of embodiments of the present invention with reference to the drawings.

### First Embodiment

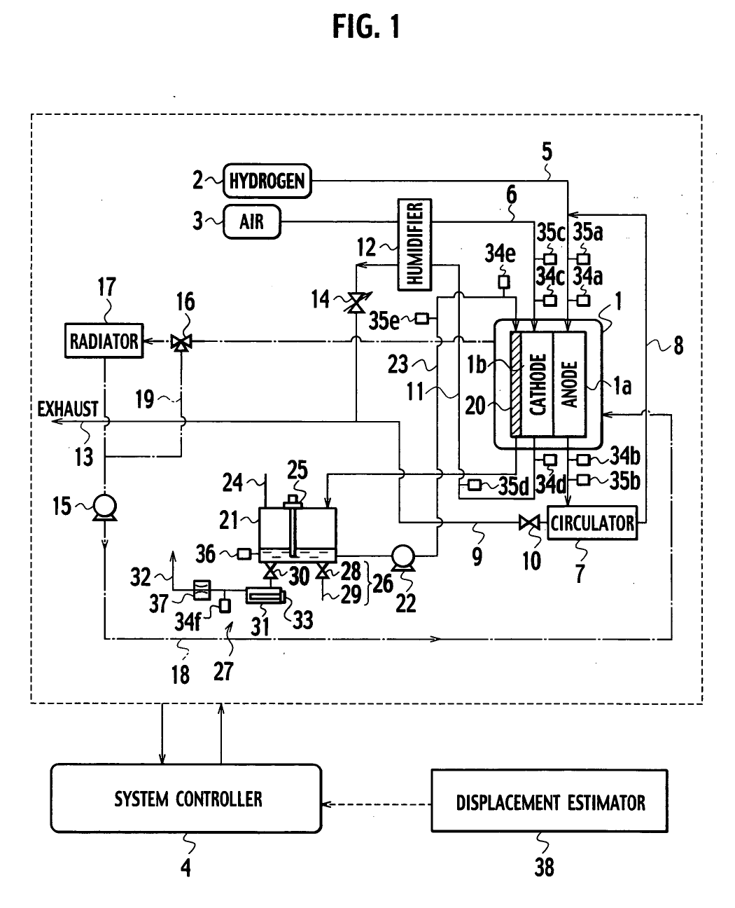

FIG. 1 shows a configuration of a fuel cell system of this embodiment. The fuel cell system of this embodiment is a system mounted on a vehicle, which serves as a drive power source of the vehicle, and uses a solid polymer-type fuel cell stack 1 as a power generation device. Moreover, in this fuel cell system, hydrogen as fuel gas is supplied from a hydrogen supply device 2 to an anode electrode 1a of the fuel cell stack 1, and in addition, air as oxidant gas is supplied from an air supply device 3 to a cathode electrode 1b of the fuel cell stack 1. Then, in the fuel cell stack 1, the supplied hydrogen and oxygen in the supplied air are reacted electrochemically with each other, and power is thus generated. Controls for various operation states in this fuel cell system are executed based on instructions from a system controller 4.

The fuel cell stack 1 is composed of single cells. Each single cell is formed in such a manner that the anode electrode 1a to which the hydrogen is supplied and the cathode electrode 1b to which oxygen (air) is supplied are superposed on each other while sandwiching therebetween an electrolyte and an electrode catalyst. Moreover, the fuel cell stack 1 has a structure in which the plural single cells are stacked on one another in a multistage manner, and converts chemical energy into electrical energy by the electrochemical reaction. In the anode electrode 1a, the hydrogen is supplied thereto, and is thus dissociated into hydrogen ions and electrons. The hydrogen ions pass through the electrolyte, and the electrons generate the power through an external circuit, and both of them move to the cathode electrode 1b individually. In the cathode electrode 1b, oxygen in the supplied air, the hydrogen ions and the electrons react mutually to generate water, and the water is discharged to the outside of the cells.

A solid polymer electrolyte membrane is used as the electrolyte of the fuel cell stack 1 in consideration of realizing a high energy density, cost reduction, weight reduction, and so on. The solid polymer electrolyte membrane is one formed of an ion conductive polymer membrane such as fluorine resin ion-exchange membrane, and functions as an ion conductive electrolyte by containing water saturatedly.

In the fuel cell system of this embodiment, as described above, the hydrogen from the hydrogen supply device 2 is supplied to the anode electrode 1a of the fuel cell stack 1 through a hydrogen supply pipe 5, and the air from the air supply device 3 is supplied to the cathode electrode 1b of the fuel cell stack 1 through an air supply pipe 6, thereby generating the power. In this case, anode off-gas containing extra hydrogen that has not been consumed for generating the power is discharged from the anode electrode 1a, and cathode off-gas containing water generated as a result of consuming a part of oxygen is discharged from the cathode electrode 1b.

The whole of anode off-gas is circulated by an anode off-gas circulator 7 to the hydrogen supply pipe 5 through a hydrogen circulation pipe 8, mixed with hydrogen newly supplied from the hydrogen supply device 2, and again, supplied to the anode electrode 1a of the fuel cell stack 1. Moreover, a hydrogen exhaust pipe 9 is branched from the anode off-gas circulator 7. A purge valve 10 provided in the hydrogen exhaust pipe 9 is opened, and the anode off-gas in which impurities are accumulated is thus discharged therefrom.

The cathode off-gas is guided to a cathode outlet pipe 11, and passes through a humidifier 12 for humidifying the air supplied to the fuel cell stack 1, and thereafter, is discharged to the outside from an exhaust pipe 13. At a downstream position of the humidifier 12, a cathode pressure regulation valve 14 is provided, and air pressure is controlled by adjusting an opening of the cathode pressure regulation valve 14.

In order to manage temperature of the fuel cell stack 1, the fuel cell stack 1 is capable of flowing a coolant sent by a coolant pump 15 with pressure therethrough. The coolant that has flown out from the fuel cell stack 1 flows through a coolant passage switching valve 16 into a radiator 17, where a heat exchange with the external air of which temperature is relatively low is performed to reduce temperature of the coolant. Thereafter, the coolant is sent with pressure by the coolant pump 15, and flows again into the fuel cell stack 1 through a coolant pipe 18.

When the temperature of the fuel cell stack 1 is relatively low, for example, when the fuel cell stack 1 is started, the opening of the coolant passage switching valve 16 is adjusted, and the coolant is bypassed from the radiator 17 by a bypass pipe 19. In such a way, the temperature of the fuel cell stack 1 is controlled to be raised to a predetermined temperature in a short time.

In the inside of the fuel cell stack 1, a water passage 20 for humidifying the supplied air and the supplied hydrogen or absorbing the generated water generated following the power generation is provided. Meanwhile, in the outside of the fuel cell stack 1, a water tank 21 for reserving a predetermined amount of water to be supplied to the fuel cell stack 1 is provided. Moreover, a water pump 22 is operated between the water passage 20 in the inside of the fuel cell stack 1 and the water tank 21 in the outside thereof, and the water is thus circulated through a water circulation pipe 23. Moreover, an air vent port 24 is provided in the water tank 21, and a configuration is adopted, in which inner pressure in the water tank 21 is maintained at the atmospheric pressure even if an amount of the generated water reserved in the water tank 21 is varied.

Note that the water passage 20 provided in the inside of the fuel cell stack 1 is usable not only for the purpose of the humidification as described above but also for the purpose of cooling the fuel cell stack 1. Specifically, the water is made to flow through the water passage 20 in the inside of the fuel cell stack 1, thus also making it possible to maintain the temperature of the fuel cell at the optimum temperature for the operation thereof.

When an amount of moisture discharged as steam in the cathode off-gas to the outside of the vehicle is larger than an amount of the generated water while the fuel cell stack 1 is generating the power, an amount of the generated water reserved in the water tank 21 decreases, and the supply of the water to the water passage 20 becomes less prone to be performed sufficiently. As a result, there is a possibility to cause lowering of performance of the fuel cell stack 1 owing to drying of the electrolyte membrane thereof. Meanwhile, when the amount of moisture discharged as the steam in the cathode off-gas to the outside of the vehicle is smaller than the amount of generated water, the amount of generated water reserved in the water tank 21 increases, and finally, the water tank 21 is filled with the generated water, and pressure in the water passage 20 increases as the inner pressure of the water tank 21 becomes larger than the atmospheric pressure. Therefore, there is a possibility to bring the lowering of the performance of the fuel cell stack 1 because the generated water remains in gas passages of the cathode 1b and the anode 1a to reduce a reaction area.

Accordingly, a liquid level estimator 25 is provided in the water tank 21, and a water level in the water tank 21, which is estimated by the liquid level estimator 25, is controlled to be maintained within a predetermined range. Specifically, when the water level is lower than a predetermined value, operation conditions such as the temperature and the pressure are changed, thereby increasing an amount of the generated water collected to the water tank 21 more than the amount of moisture discharged to the outside of the vehicle. On the contrary, when the water level is higher than the predetermined value, the water in the water tank 21 is discharged to the outside of the vehicle by a discharge device provided in the water tank 21, thereby maintaining the water level within the predetermined range.

In particular, in the fuel cell system of this embodiment, as such a discharge device for discharging the water in the water tank 21 to the outside of the vehicle, provided are a liquid-water discharge device 26 for discharging the extra water from the water tank 21 to the outside of the vehicle in a state of liquid-water, and a steam discharge device 27 for evaporating the extra water and discharging steam resulting therefrom to the outside of the vehicle. In usual, the extra water in the water tank 21 is discharged directly as the liquid-water from the liquid-water discharge device 26.

The liquid-water discharge device 26 is composed of, for example, a shut-off valve 28 and a discharge pipe (discharge passage) 29, and it is made possible to control an amount of discharge water discharged in the state of the liquid-water from the discharge pipe 29 by controlling an opening time of the shut-off valve 28.

Meanwhile, the steam discharge device 27 has a configuration, in which a buffer tank 31 and an air vent pipe (exhaust passage) 32 are connected to the water tank 21 with the shut-off valve 30 interposed therebetween, and an electric heater 33 is provided as a heater on the buffer tank 31. Moreover, the steam discharge device 27 is made capable of temporarily reserving the extra water discharged from the water tank 21 in the buffer tank 31, heating and evaporating the water reserved in the buffer tank 31 by means of the electric heater 33, and discharging the evaporated water as steam from the air vent pipe 32 to the outside of the vehicle.

Note that, in the fuel cell system of this embodiment, pressure detectors 34a, 34b, 34c, 34d and 34e and temperature detectors 35a, 35b, 35c, 35d and 35e are provided in an inlet and outlet of the anode electrode 1 a, an inlet and outlet of the cathode electrode 1b and an inlet of the water passage 20 of the fuel cell stack 1, respectively, a water tank temperature detector 36 is provided in the water tank 21, and a pressure detector 34f and a restrictor 37 are provided in an outlet of the buffer tank 31 of the steam discharge device 27.

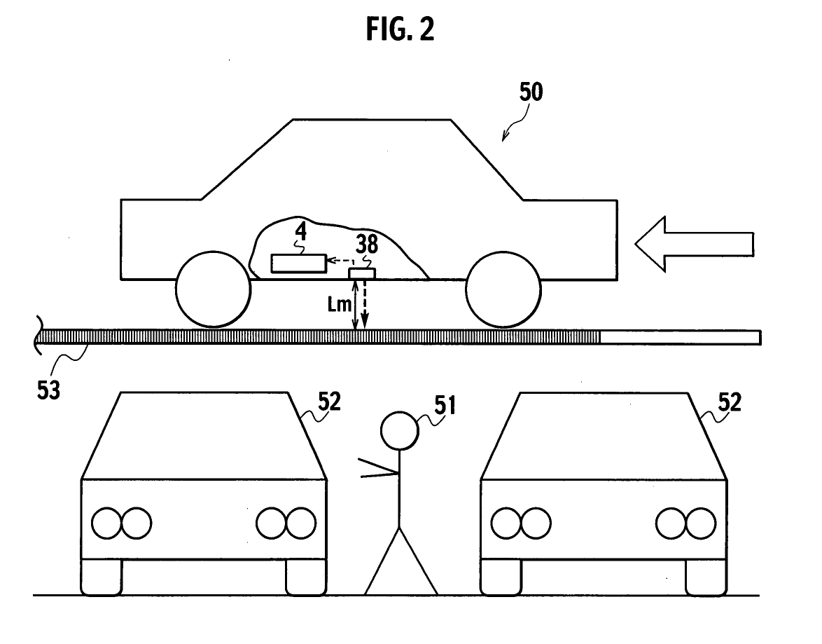

Moreover, the fuel cell system of this embodiment is configured as the on-vehicle fuel cell system as described above, and a displacement estimator 38 is provided in the vehicle on which the fuel cell system is mounted. As shown in FIG. 2, the displacement estimator 38 estimates a distance Lm from a bottom surface of a vehicle body 50 to a road surface immediately under the vehicle body. A non-contact displacement sensor and the like are usable as the displacement estimator. Moreover, in the fuel cell system of this embodiment, the system controller 4 estimates a road surface condition immediately under the vehicle based on the distance to the road surface immediately under the vehicle. For example, as shown in FIG. 2, when it is assumed by an estimation of the system controller 4 that a space allowing a person 51 and other vehicles 52 to be present therein exists immediately under the vehicle 50, the fuel cell system controls the discharge of the water by the discharge devices not to discharge the liquid-water to the outside of the vehicle. In this connection, FIG. 2 shows a cross section of a multi-storied parking having a floor surface formed of a mesh steel plate, and reference numeral 53 denotes the mesh steel plate.

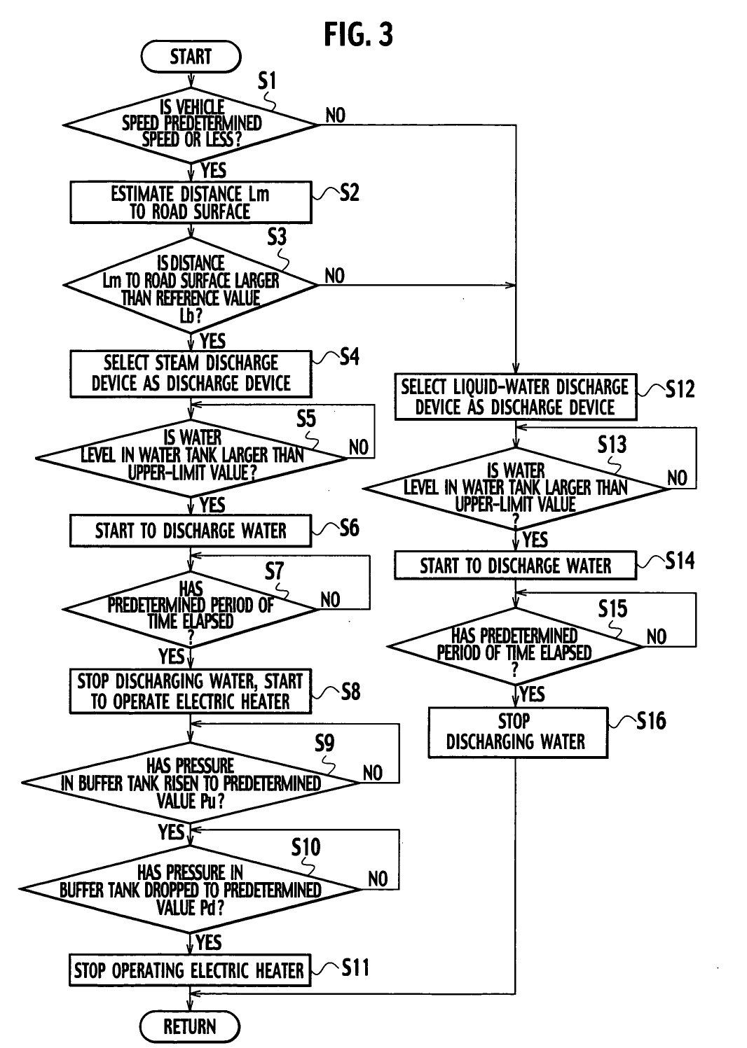

Description is made below in detail of such a discharge control by the system controller 4, which is characteristic in the fuel cell system of this embodiment, with reference to a flowchart of FIG. 3.

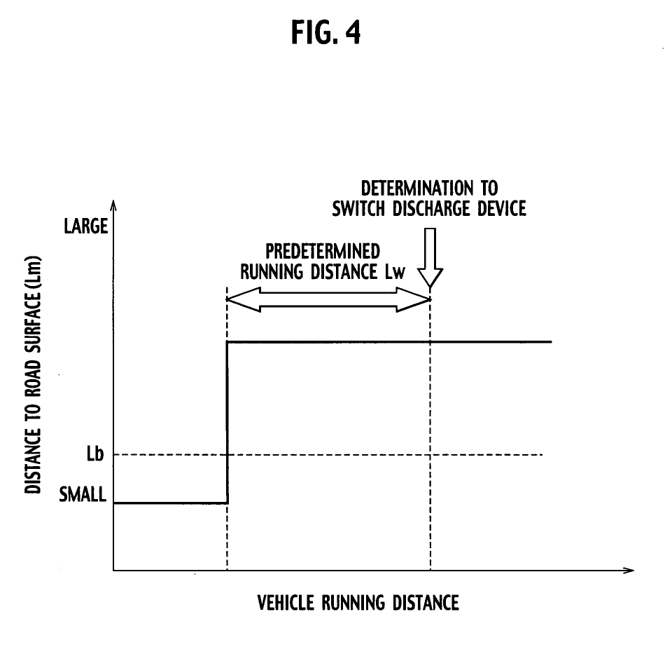

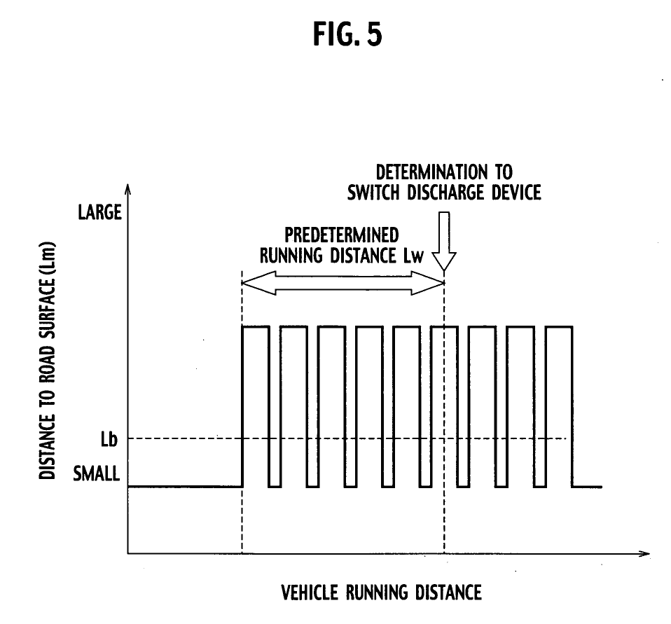

In the fuel cell system of this embodiment, the system controller 4 first reads information from a vehicle-speed sensor provided in the vehicle, and determines whether or not vehicle speed is equal to or less than a predetermined speed set in advance (Step S1). When the vehicle speed is equal to or less than the predetermined speed, the system controller 4 starts to estimate the distance Lm to the road surface immediately under the vehicle by using the displacement estimator 38 (Step S2). Then, the system controller 4 determines whether or not the distance Lm, which is estimated by means of the displacement estimator 38, exceeds a reference value Lb over a predetermined vehicle running distance Lw set in advance (Step S3). In this case, the distance Lm may exceed the reference value Lb continuously as shown in FIG. 4, or may exceed the reference value Lb intermittently as shown in FIG. 5. This reference value Lb is preset in consideration of unevenness of a usual road surface. When the distance Lm exceeds the reference value Lb continuously or intermittently over the predetermined vehicle running distance Lw, the system controller 4 determines that a relatively large space exists immediately under the vehicle, and selects the steam discharge device 27 as the device for discharging the extra water in the water tank 21 so as not to discharge the extra water in the water tank 21 in the state of the liquid-water (Step S4).

Specifically, in the fuel cell system of this embodiment, when the distance Lm to the road surface immediately under the vehicle is continuously larger than the reference value Lb as shown in FIG. 4, it is assumed that there is possibly a space such as a pit of a vehicle dock, where a person can be easily present, exists immediately under the vehicle. Moreover, when the distance Lm is intermittently larger than the reference value Lb as shown in FIG. 5, it is assumed that there is possibly a space such as the multi-storied parking having the floor surface formed of the mesh steel plate, where a person, an article and an automobile can be easily present, exists immediately under the vehicle. In order to avoid the discharged liquid-water from falling down on these person, article and automobile, the discharge device is switched to the steam discharge device 27, and the extra water is thus avoided from being discharged in the state of the liquid-water.

Moreover, from a viewpoint that there is less possibility to drive the vehicle while increasing the vehicle speed under a situation where the space exists, which allows the person, the article and the automobile to be easily present immediately under the vehicle, the distance Lm is assumed in the following manner in the fuel cell system of this embodiment. The maximum speed assumable when the vehicle runs on a place having the space allowing the person, the article and the automobile to be easily present immediately under the vehicle is predetermined, and the distance Lm to the road surface immediately under the vehicle is assumed by using the displacement estimator 38 only in the case where the running speed is equal to or less than the predetermined vehicle speed. In such a way, a situation where the estimation of the road surface condition is performed is limited only to the time when the vehicle runs at low speed. Accordingly, the configuration of the control system can be simplified, and energy required for operating the displacement estimator 38 can be saved.

In the case of having selected the steam discharge device 27 as the device for discharging the extra water in the water tank 21 in Step S4, the system controller 4 next determines whether or not the water level in the water tank 21 has exceeded an upper-limit value thereof while monitoring the estimated value of the liquid level estimator 25 (Step S5). When the water level in the water tank 21 has exceeded the upper-limit value, the system controller 4 opens the shut-off valve 30 to discharge the extra water from the water tank 21, and temporarily reserves the extra water in the buffer tank 31 (Step S6). Then, in a step where a predetermined period of time has elapsed since the discharge of the water from the water tank 21 was started (Step S7), the system controller 4 closes the shut-off valve 30 to stop the discharge of the water, and starts to operate the electric heater 33 (Step S8).

By the operation of the electric heater 33, the water reserved in the buffer tank 31 will be evaporated and discharged as the steam from the air vent pipe 32 to the outside of the vehicle. In this case, since the restrictor 37 is provided in the air vent pipe 32 as described above, pressure on an upstream side of the restrictor 37 in the air vent pipe 32 and pressure in the buffer tank 31 will be varied following the generation of the steam. Accordingly, after staring to operate the electric heater 33 in Step S8, the system controller 4 monitors a detected value of the pressure detector 34f provided in the outlet of the buffer tank 31. Then, in a step where the pressure in the buffer tank 31 drops to a predetermined value Pd set in advance or less (Step S10) after rising to the predetermined value Pu set in advance or more following the generation of the steam (Step S9), the system controller 4 determines that the evaporation of the water reserved in the buffer tank 31 is completed, and stops the operation of the electric heater 33 (Step S1).

By the discharge control described above, the water reserved in the buffer tank 31 can be surely evaporated and can be discharged as the steam to the outside of the vehicle while restricting energy required for the electric heater 33 to the minimum necessary. Moreover, the water discharged to the outside of the vehicle is temporarily reserved in the buffer tank 31, and is heated and evaporated here. Accordingly, there is hardly an influence on the temperature of the water in the water tank 21, and eventually, on the temperature of the water supplied to the fuel cell stack 1, and a normal operation can be continued.

As above, description has been made of the discharge control in the case where the steam discharge device 27 has been selected as the discharge device as a result of the determination that the road surface condition immediately under the vehicle is not suitable for the discharge of the extra water in the state of the liquid-water. Meanwhile, in the case of having determined in the above-described Step S1 that the vehicle speed exceeds the predetermined speed, or in the case of having determined in the above-described Step S3 that the distance Lm to the road surface immediately under the vehicle does not show a larger value than the reference value Lb continuously or intermittently over the predetermined running distance Lw, the system controller 4 determines that there is no problem to discharge the extra water in the water tank 21 to the outside of the vehicle in the state of the liquid-water, and selects the liquid-water discharge device 26 as the device for discharging the extra water in the water tank 21 (Step S12).

In the case of having selected the liquid-water discharge device 26 as the discharge device as described above, the system controller 4 determines whether or not the water level in the water tank 21 has exceeded the upper-limit value thereof while monitoring the estimated value of the liquid level estimator 25 (Step S13). When the water level in the water tank 21 has exceeded the upper-limit value, the system controller 4 opens the shut-off valve 28, thereby discharging the extra water in the water tank 21, in the state of the liquid-water, to the outside of the vehicle through the discharge pipe 29 (Step S14). Then, in a step where a predetermined period of time has elapsed since the discharge of the water from the water tank 21 was started (Step S15), the system controller 4 closes the shut-off valve 28, thereby stopping the discharge of the water (Step S16).

As described above, according to the fuel cell system of this embodiment, the road surface condition immediately under the vehicle is estimated by using the displacement estimator 38. Moreover, when the road surface condition is estimated not suitable for the discharge of the extra water in the state of the liquid-water, for example, when a relatively large space exists immediately under the vehicle, the steam discharge device 27 is selected as the device for discharging the extra water in the water tank 21 to avoid the discharge of the liquid-water to the outside of the vehicle. Therefore, for example, even in such a case where the person, the article, the automobile and the like are present in the space immediately under the vehicle, a disadvantage of causing wet damage to these person, article, automobile and the like by a careless discharge can be prevented effectively.

Moreover, according to the fuel cell system of this embodiment, the steam discharge device 27 is provided as the discharge device in combination with the liquid-water discharge device 26 for discharging the extra generated water in the state of the liquid-water. In the case of performing the discharge under the situation where the road surface condition is estimated not suitable for the discharge of the extra water in the state of the liquid-water, the extra water in the water tank 21 is evaporated by the steam discharge device 27 and discharged as the steam to the outside of the vehicle. Therefore, a management of the water level in the water tank 21 can be performed appropriately and the operation of the fuel cell system can be continued while avoiding damage and an adverse effect on the periphery owing to the discharge of the liquid-water.

Furthermore, in the fuel cell system of this embodiment, the distance to the road surface immediately under the vehicle is estimated by the displacement estimator 38. When the distance from the vehicle to the road surface is larger than the predetermined value continuously or intermittently as a result of the estimation, it is automatically determined that the vehicle is located in a place unsuitable for the discharge of the generated water, for example, the multi-storied parking having the floor surface formed of the mesh steel plate, and the control is made so as not to discharge the liquid-water to the outside of the vehicle. Therefore, the possibility of causing the wet damage by spraying the generated water on the person, the article, the automobile and the like immediately under the vehicle owing to the discharge of the liquid-water at the unsuitable place can be reduced as much as possible.

Still further, according to the fuel cell system of this embodiment, the road surface condition is estimated only when the vehicle speed of the vehicle on which the fuel cell system concerned is mounted is lower than the predetermined speed. Accordingly, the configuration of the control system can be simplified, and the energy required for operating the displacement estimator 38 can be saved.

### Second Embodiment

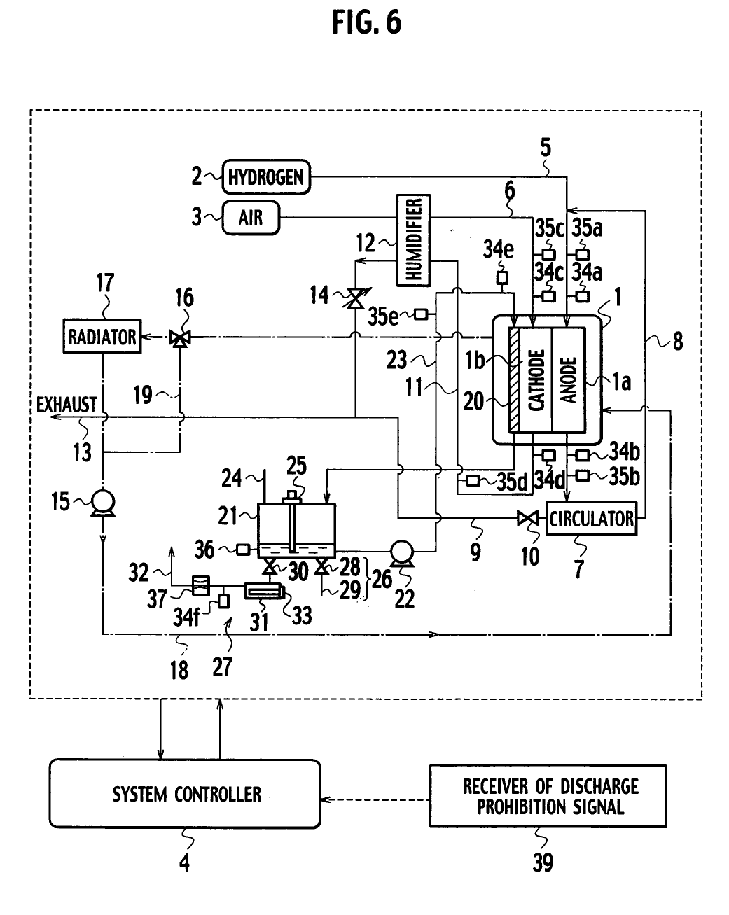

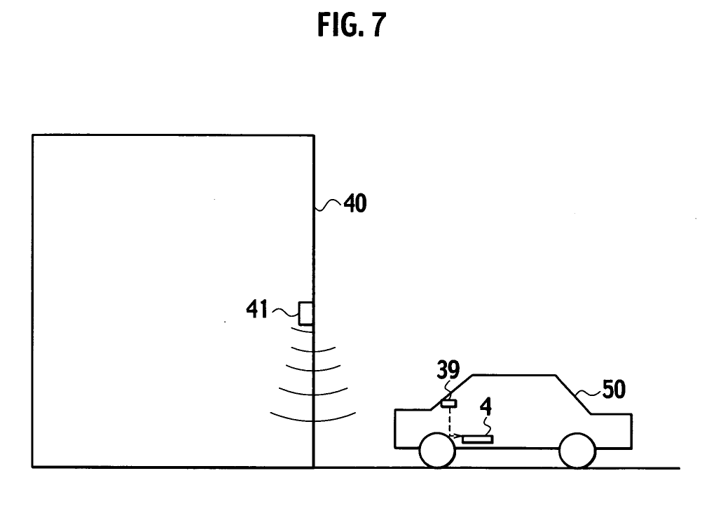

Next, a fuel cell system of a second embodiment to which the present invention is applied is described. As shown in FIG. 6 and FIG. 7, the fuel cell system of this embodiment has a feature in that a receiver 39 of a discharge prohibition signal is provided in place of the displacement estimator 38 for use in estimating the road surface condition in the above-described first embodiment. Note that other basic configurations of the system are similar to those of the above-described first embodiment.

The receiver 39 is one for receiving the discharge prohibition signal transmitted from a transmitter 41 provided in a facility 40 or the like in the outside of the vehicle. Specifically, in this embodiment, a transmitter 41 for transmitting the discharge prohibition signal to the effect that the discharge of the extra water in the state of the liquid-water is prohibited is provided in the facility 40 or the like having the space allowing the person, the article and the automobile to be present therein under the floor surface on which the vehicle can move. Then, when the vehicle on which the fuel cell system of this embodiment is mounted approaches the transmitter 41 and receives, by the on-vehicle receiver 39, the discharge prohibition signal from the transmitter 41, the system controller 4 switches the discharge device to the steam discharge device 27, thereby discharging the extra water not in the state of the liquid-water but in the state of the steam when such a discharge to the outside of the vehicle is necessary.

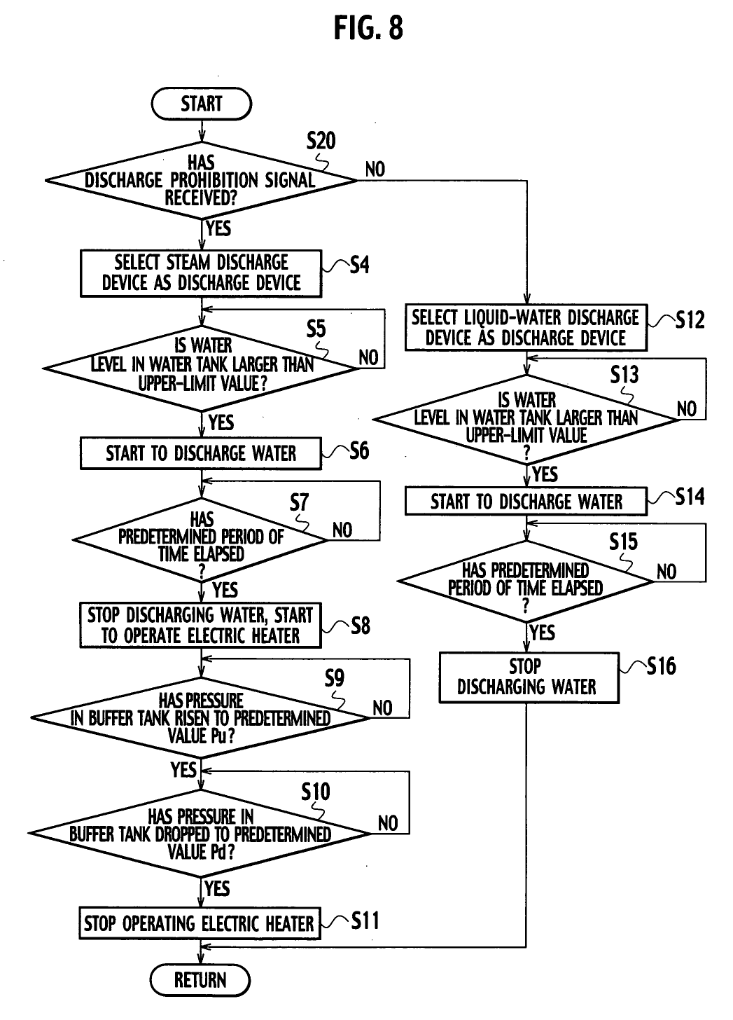

FIG. 8 shows a control flow of the discharge control in the fuel cell system of this embodiment. In the flow of FIG. 8, in place of Steps S1 to Step S3 of the control flow shown in FIG. 3, it is determined in Step S20 whether or not the discharge prohibition signal has been received. Then, in the case of having received the discharge prohibition signal, the steam discharge device 27 is selected as the discharge device in Step S4. In the case of not having received the discharge prohibition signal, the liquid-water discharge device 26 is selected in Step S12. Other processes are similar to the processes in the first embodiment, which are shown in FIG. 3.

As described above, in the fuel cell system of this embodiment, when the receiver 39 has received the discharge prohibition signal from the transmitter 41 provided in the facility 40 or the like having the space allowing the person, the article and the automobile to be present therein under the floor surface, the discharge device for discharging the extra water in the water tank 21 is switched to the steam discharge device 27, thereby making the control not to discharge the liquid-water to the outside of the vehicle. Accordingly, the place unsuitable for the discharge of the liquid-water can be definitely determined, and the disadvantage in that the liquid-water drops down on the person, the article and the automobile in the outside of the vehicle can be surely avoided.

Note that, though the fuel cell system of this embodiment includes the receiver 39 of the discharge prohibition signal in place of the displacement estimator 38 of the first embodiment, the fuel cell system may include both of the receiver 39 and the displacement estimator 38.

### Third Embodiment

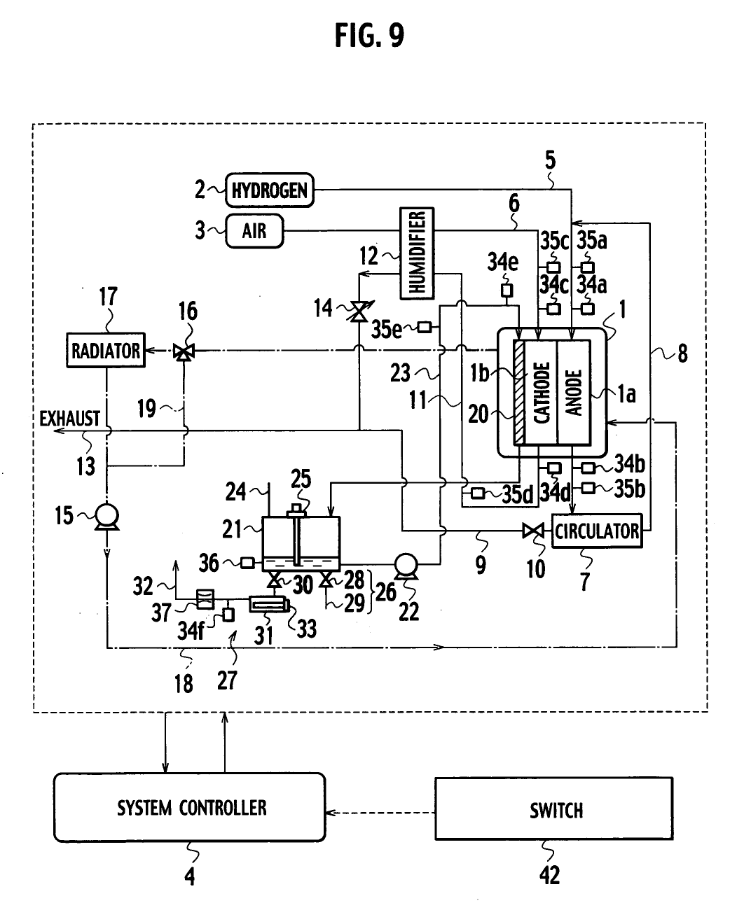

Next, a fuel cell system of a third embodiment to which the present invention is applied is described. As shown in FIG. 9, the fuel cell system of this embodiment has a feature in that a switch 42 arbitrarily switchable by a passenger on the vehicle is provided in place of the displacement estimator 38 for use in estimating the road surface condition in the above-described first embodiment. Note that other basic configurations of the system are similar to those of the above-described first embodiment.

In the fuel cell system of this embodiment, when the passenger on the vehicle has determined that the road surface condition immediately under the vehicle is a road surface condition unsuitable for the discharge of the extra water in the state of the liquid-water as a result of a confirmation of the road surface condition by viewing the same, and so on, the steam discharge device 27 can be selected as the device for discharging the extra water in the water tank 21 by switching the switch 42. Specifically, in the fuel cell system of this embodiment, the system controller 4 is adapted to monitor a state of the switch 42, and to switch the discharge device in response to the state of the switch 42.

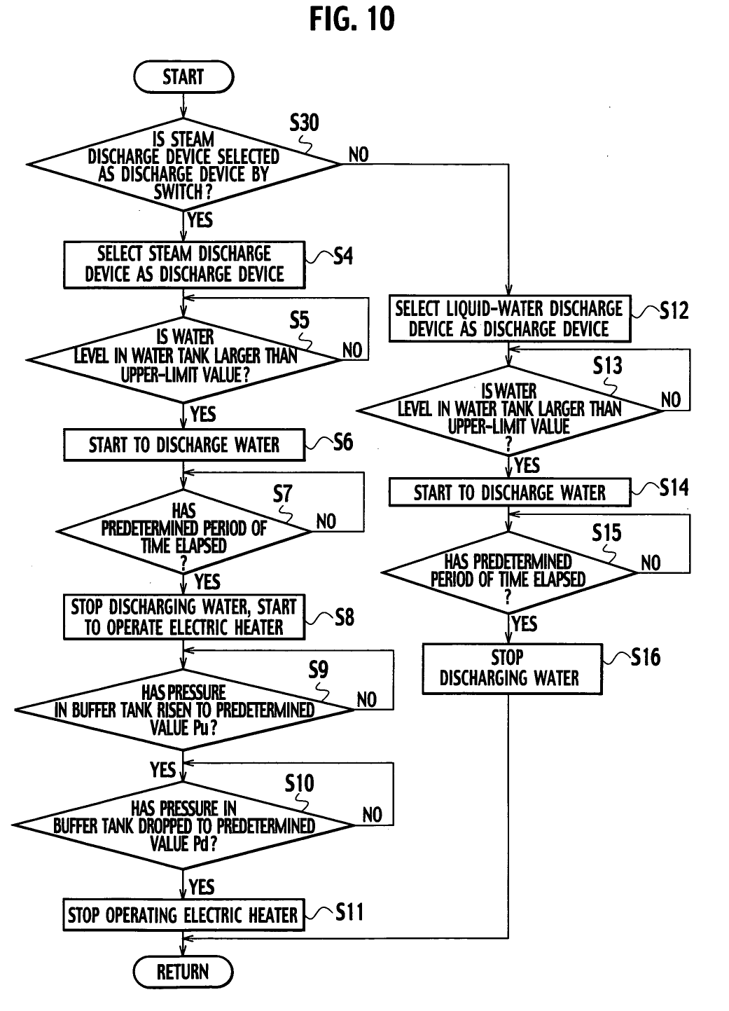

FIG. 10 shows a control flow of the discharge control in the fuel cell system of this embodiment. In the flow of FIG. 10, in place of Steps SI to Step S3 of the control flow shown in FIG. 3, in Step S30, the state of the switch 42 is determined. Then, in the case where the steam discharge device 27 is designated by the switch 42, the steam discharge device 27 is selected as the discharge device in Step S4. Meanwhile, in the case where the liquid-water discharge device 26 is designated by the switch 42, the liquid-water discharge device 26 is selected in Step S12. Other processes are similar to the processes in the first embodiment, which are shown in FIG. 3.

As described above, in the fuel cell system of this embodiment, the switch 42 arbitrarily selectable by the passenger on the vehicle is provided. In the case where the road surface condition is designated to be unsuitable for the discharge of the extra water in the state of the liquid-water by the operation of the switch 42, the discharge device for discharging the extra water in the water tank 21 is switched to the steam discharge device 27, thereby making the control not to discharge the liquid-water to the outside of the vehicle. Accordingly, the optimum discharge control of the water can be made according to the circumstances by the determination of the passenger on the vehicle while simplifying the system configuration.

Note that, though the fuel cell system of this embodiment includes the switch 42 in place of the displacement estimator 38 of the first embodiment, the fuel cell system may include both of the switch 42 and the displacement estimator 38.

The entire content of a Japanese Patent Application No. P2004-281423 with a filing date of Sep. 28, 2004 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. An on-vehicle fuel cell system, comprising:
a fuel cell stack which is mounted on a vehicle and generates power by using fuel gas and oxidant gas, the fuel cell stack including a water passage which performs cooling and humidification in an inside thereof;
a water circulator which circulates water through the water passage;
a water tank which reserves the water;
a discharge device which discharges extra water from the water tank to an outside of the vehicle; and
a discharge control device which controls the discharge of the water by the discharge device,
wherein the discharge control device makes a control not to discharge liquid-water to the outside of the vehicle in a case where a road surface condition immediately under the vehicle is estimated to be a predetermined road surface condition.

2. The on-vehicle fuel cell system of claim 1,
wherein the discharge device comprises a liquid-water discharge device which discharges the extra water in a state of the liquid-water, and a steam discharge device which discharges the extra water in a state of steam, and
the discharge control device discharges the extra water by the steam discharge device when the road surface condition immediately under the vehicle is estimated to be a road surface condition unsuitable for the discharge of the extra water in the state of the liquid-water.

3. The on-vehicle fuel cell system of claim 2,
wherein the liquid-water discharge device comprises a discharge passage and a first shut-off valve, through which the liquid-water passes,
the steam discharge device comprises a buffer tank which temporarily reserves the extra water discharged from the water tank, the buffer tank being connected to the water tank with a second shut-off valve interposed therebetween, a heater which evaporates the water reserved in the buffer tank, and an exhaust passage which discharges the steam evaporated by the heater, and
in a case of discharging the extra water by the steam discharge device, the discharge control device sends a necessary amount of the water from the water tank to the buffer tank, allows the heater to evaporate the water, and discharges the water as the steam from the exhaust passage.

4. The on-vehicle fuel cell system of claim 1, further comprising;
a displacement estimator which estimates a distance from a bottom surface of a vehicle body to a road surface immediately under the vehicle body,
wherein the discharge control device makes the control not to discharge the liquid-water to the outside of the vehicle in a case where the distance is larger than a predetermined value continuously or intermittently.

5. The on-vehicle fuel cell system of claim 1,.
wherein the discharge control device performs processing for estimating the road surface condition when running speed of the vehicle is equal to or less than a predetermined speed.

6. The on-vehicle fuel cell system of claim 1, further comprising;
a receiver which receives a signal to an effect that the discharge of the extra water in the state of the liquid-water is to be prohibited, the signal being transmitted from a transmitter provided in the outside of the vehicle,
wherein the discharge control device makes the control not to discharge the liquid-water in a case where the receiver has received the signal.

7. The on-vehicle fuel cell system of claim 1, further comprising;
a switch which switches the liquid-water discharge device and the steam discharge device,
wherein the discharge control device makes a control not to discharge the extra water by the liquid-water discharge device in a case where the steam discharge device has been selected by an operation of the switch by a passenger on the vehicle.

8. A fuel cell system controlling method, comprising:
preparing a fuel cell stack which is mounted on a vehicle and generates power by using fuel gas and oxidant gas, the fuel cell stack including a water passage which performs cooling and humidification in an inside thereof, a water circulator which circulates water through the water passage, a water tank which reserves the water, and a discharge device which discharges extra water from the water tank to an outside of a vehicle,
estimating a road surface condition immediately under the vehicle; and
controlling the discharge device not to discharge liquid-water to the outside of the vehicle in a case where the road surface condition is estimated to be a predetermined road surface condition.

9. An on-vehicle fuel cell system, comprising:
a fuel cell stack which is mounted on a vehicle and generates power by using fuel gas and oxidant gas, the fuel cell stack including a water passage which performs cooling and humidification in an inside thereof;
a water circulator which circulates water through the water passage;
a water tank which reserves the water;
discharge means for discharging extra water from the water tank to an outside of the vehicle; and
discharge control means for controlling the discharge of the water by the discharge means,
wherein the discharge control means makes a control not to discharge liquid-water to the outside of the vehicle in a case where a road surface condition immediately under the vehicle is estimated to be a predetermined road surface condition.
